(19) United States
(12) Patent Application Publication
(10) Pub. No.: US 2025/0050155 A1
(43) Pub. Date: Feb. 13, 2025

(54) FIRE EXTINGUISHING LIQUID

(71) Applicant: LIFESAFE TECHNOLOGIES LIMITED, Essex (GB)

(72) Inventor: Gavin CORNELIUS, Essex (GB)

(21) Appl. No.: 18/710,937

(22) PCT Filed: Nov. 18, 2022
(86) PCT No.: PCT/EP2022/082435

§ 371 Date: May 16, 2024

(30) Foreign Application Priority Data
Nov. 19, 2021 (GB) 2116728.3

(51) Int. Cl. A62D 1/00; A62D 1/02

(52) U.S. Cl. CPC A62D 1/005; A62D 1/0071

(57) ABSTRACT

A fire extinguishing liquid is described comprising (a) one or more of a phosphate, hydrogen phosphate, dihydrogen phosphate or polyphosphate salt; (b) a carbonate or hydrogen carbonate salt; (c) a sulphate salt; and (d) an intumescent component. Methods of manufacturing the fire extinguishing liquid and fire extinguishers containing the liquid are also described. The liquid is useful for extinguishing fires, in particular lithium-ion battery fires.

### RELATED APPLICATIONS

This application claims the priority of UK patent application GB 2116728.3 filed on 19 Nov. 2021, the contents of which are incorporated by reference herein in their entirety.

### TECHNICAL FIELD OF THE INVENTION

The present invention relates to fire extinguishing liquids, methods of manufacturing fire extinguishing liquids, and fire extinguishers containing those liquids.

### BACKGROUND TO THE INVENTION

Some fire extinguishers are filled with liquid, herein referred to as ‘fire extinguishing liquid’. There are a number of properties which are desirable for the fire extinguishing liquid. Firstly, it must be effective at suppressing and extinguishing fires. This can be achieved in a number of ways, which are discussed in detail in the “Summary of the Invention” section below. The components contained in the fire extinguishing liquid are selected to maximize its effectiveness.

There is a need for further fire extinguishing liquids which are effective against a range of different types of fire. Different types of fire according to the European standard EN3 include Class A (fires involving organic solids, e.g. wood, paper), Class B (fires involving flammable liquids), Class C (fires involving flammable gases), Class D (fires involving combustible metals) and Class F (fires involving cooking oil and fat). It is rare for a given fire extinguishing liquid to be effective against multiple fire types.

At present there is an increasing need for fire extinguishing liquids which are effective against lithium-ion (Li-ion) battery fires, especially given the ever-increasing number of electric vehicles (EVs) making their way onto the roads. A Li-ion battery contains an electrolyte between an anode and a cathode. The anode tends to be graphite and the cathode is a material having the ability to react with lithium ions. The electrolyte contains lithium salts and is flammable. Despite the name, lithium-ion batteries do not contain any lithium metal and so fire extinguishing compositions which are tailored for metal fires are not suitable. Due to the flammability of the electrolyte, a Li-ion battery fire is akin to a liquid hydrocarbon fire. As such, Li-ion battery fires have more in common with a Class B fire, but in fact fall outside the criteria for both Class B and Class D fires.

Li-ion batteries within EVs are particularly hazardous. EV batteries are designed to be lightweight with a high power-density, meaning that the walls of the cells are thin and the electrolyte is pressurised. The electrodes also tend to be thin, composed of materials which could rupture and deposit fragments into the electrolyte upon impact, further increasing the flammability of the electrolyte. EV batteries are of course also prone to impact caused by traffic collisions. Such impacts could easily rupture the thin walls of the structural battery components and release the pressurised flammable electrolyte. This leads to a composition which could easily ignite and is potentially explosive, presenting a hazard to the occupants of the vehicle and any passers-by. One hazardous aspect of Li-ion batteries is that as you attempt to remove the wreckage, the debris moves through the pressurised electrolyte risking reignition. The potential for reignition in this way lasts for up to 14 days after the original collision.

US 2019/308043 A1 describes a powdered composition (“fire suppression agent”) with the purpose of extinguishing Li-ion battery fires. The fire suppression agent contains dry chemical agent and vermiculite particles. There are a number of problems with the composition described. The powdered nature of the composition leads to a reduction is visibility when the composition is discharged, which is dangerous in the vicinity of an extremely hot and explosive Li-ion battery fire. Furthermore, the airborne particulates can cause breathing difficulties for anyone in the immediate vicinity of discharge. It is very difficult to direct the powder towards the fire itself and the whole surrounding area is likely to become covered in powder, which is inefficient, messy and causes unnecessary expensive damage to materials and the environment.

Furthermore, the basic composition described in US 2019/308043 A1 has limited fire-suppressing capabilities due to the complex and high-temperature properties of a Li-ion battery fire.

There is a need for fire extinguishing liquids which are effective in dealing with the unique challenges presented by a Li-ion battery fire.

It is also desirable for fire extinguishing liquids to be effective over a wide range of temperatures. However, particularly in cold climates, the types of fire extinguisher which can be used are restricted. This is because the fire extinguishing liquid is often stored in pressurized containers, and there are safety risks associated with the liquid freezing. In addition to the safety risks, the low temperature can cause (a) freezing of the fire extinguishing liquid and (b) dissolved components in the liquid to come out of solution. Solid particulate matter inside the fire extinguisher can lead to undesirable consequences such as clogging of the nozzle.

It is also an aim of the invention to provide a liquid firefighting composition which is environmentally friendly and has a minimal detrimental impact on the environment when discharged to fight a fire.

### SUMMARY OF THE INVENTION

Broadly speaking, the present invention provides a fire extinguishing liquid which demonstrates an improved ability to extinguish Li-ion battery fires quickly and safely relative to known compositions. In order to achieve this, a first aspect of the present invention provides a fire extinguishing liquid comprising:
(a) one or more of a phosphate, hydrogen phosphate, dihydrogen phosphate or polyphosphate salt;
(b) a carbonate or hydrogen carbonate salt;
(c) a sulphate salt; and
(d) an intumescent component.

The inventors have found that such a fire extinguishing liquid is particularly effective in extinguishing Li-ion battery fires. The combination of one or more of a phosphate, hydrogen phosphate, dihydrogen phosphate or polyphosphate salt, with a carbonate or hydrogen carbonate salt and a sulphate salt has a suffocating effect on the fire as explained in more detail below. However it was found that due to the extreme temperature of a Li-ion battery fire, these components alone would evaporate before they were able to exert their fire-suppressing effects, reducing the effectiveness of the composition against Li-ion battery fires. It has been found that the particular combination of these components with an intumescent component addresses this problem. The intumescent component expands upon exposure to the extreme heat of the Li-ion fire and creates a pasty emulsion which eventually forms a shell or barrier which allows the other components of the composition to remain at the location of the fire and exert extinguishing properties. The hardening of the emulsion formed by the expansion of the intumescent component also itself provides a suppressive barrier which acts to starve the fire of oxygen.

The fire extinguishing liquid is environmentally friendly, with the composition being less damaging to the environment than known fire extinguishing liquid compositions.

Herein, phosphate, hydrogen phosphate and dihydrogen phosphate salts are salts including the anions PO₄³⁻, HPO₄²⁻ and H₂PO₄⁻ respectively. A polyphosphate salt is a salt of polyphosphoric acid.

A hydrogen carbonate salt is a salt including the anion HCO₃⁻.

A sulphate salt is a salt including the anion SO₄²⁻.

Preferably, the salts are each water-soluble. In some embodiments, each of the salts has a solubility in distilled water at 20° C. of at least 5 g/100 mL, for example at least 6 g/100 mL, for example at least 10 g/100 mL, for example at least 15 g/100 mL, for example at least 20 g/100 mL.

The counter-ion to the above-mentioned anions may be selected from any suitable cation which combines with the anion to form a salt having the above solubility. Non-limiting examples of cations are alkali metal ions, alkaline earth metal ions, transition metal ions and organic cations such as ammonium ion (NH₄⁺) or primary, secondary, tertiary or quaternary ammonium cations (NH₃R⁺; NH₂R₂⁺; NHR₃⁺ or NR₄⁺ respectively, wherein each R is independently selected from C₁₋₄ saturated alkyl groups). Preferably, the counter cation is selected from alkali metal ions, alkaline earth metal ions and ammonium ion (NH₄⁺).

In some embodiments, the phosphate salt is selected from trisodium phosphate (Na₃PO₄) and tripotassium phosphate (K₃PO₄).

In some embodiments, the hydrogen phosphate salt is selected from disodium phosphate (Na₂HPO₄), dipotassium phosphate (K₂HPO₄) and diammonium hydrogen phosphate ((NH₄)₂HPO₄). In some embodiments, the hydrogen phosphate salt is diammonium hydrogen phosphate ((NH₄)₂HPO₄).

In some embodiments, the dihydrogen phosphate salt is selected from monosodium phosphate (NaH₂PO₄), monopotassium phosphate (KH₂PO₄) and monoammonium phosphate ((NH₄)H₂PO₄).

In some embodiments, the polyphosphate salt is ammonium polyphosphate (APP).

In some embodiments, the carbonate salt is ammonium carbonate (NH₄)₂CO₃.

In some embodiments, the hydrogen carbonate salt is selected from sodium hydrogen carbonate (NaHCO₃), potassium hydrogen carbonate (KHCO₃) and ammonium hydrogen carbonate ((NH₄)HCO₃). In some embodiments, the hydrogen carbonate salt is ammonium hydrogen carbonate ((NH₄)HCO₃).

In some embodiments, the sulphate salt is selected from sodium sulphate (Na₂SO₄), potassium sulphate (K₂SO₄) and ammonium sulphate ((NH₄)₂SO₄). In some embodiments, the sulphate salt is ammonium sulphate ((NH₄)₂SO₄). Ammonium sulfate is an effective ingredient against Li-ion battery fires because it increases the acidity of the fire extinguishing liquid which is important to neutralise the alkaline electrolyte of a Li-ion cell.

In some embodiments, component (a) is a hydrogen phosphate salt, i.e. a salt including the anion HPO₄²⁻.

Particularly good fire extinguishing properties are observed for the fire extinguishing liquid when the salts in components (a), (b) and (c) are each ammonium salts. Without wishing to be bound by theory, it is believed that this may be at least partly due to the increased quantity of ammonia produced through thermal decomposition of ammonium salts, which has a suffocating effect on the fire.

Thus in some embodiments, the fire extinguishing liquid comprises:
diammonium hydrogen phosphate ((NH₄)₂HPO₄),
ammonium bicarbonate (NH₄HCO₃),
ammonium sulphate ((NH₄)₂SO₄), and
an intumescent component.

In some embodiments, component (a) (the phosphate, hydrogen phosphate, dihydrogen phosphate or polyphosphate salt) consists of a hydrogen phosphate salt. In some embodiments, component (a) (the phosphate, hydrogen phosphate, dihydrogen phosphate or polyphosphate salt) consists of diammonium hydrogen phosphate ((NH₄)₂HPO₄).

In some embodiments, component (b) (the carbonate or hydrogen carbonate salt) consists of ammonium bicarbonate (NH₄HCO₃).

In some embodiments, component (c) (the sulphate salt) consists of ammonium sulphate ((NH₄)₂SO₄).

The intumescent component is a component which, under the influence of high temperature, swells or expands (i.e. experiences an increase in volume). The intumescent component of the composition comprises one or more compounds or materials which have intumescent properties.

The intumescent component may consist of a single type of intumescent material, or may consist of a mixture of two or more types of intumescent material.

In some embodiments, the intumescent component comprises one or more solid intumescent materials.

In some embodiments, the intumescent component comprises one or more intumescent materials which experience an increase in volume of at least 100%, for example at least 200% when exposed to a temperature of 200° C.

In some embodiments, the intumescent component comprises perlite. Perlite is an amorphous volcanic glass which is naturally occurring. It is primarily formed of silicon dioxide but contains other inorganic compounds.

In some embodiments, the intumescent component comprises vermiculite. Vermiculite is a hydrous phyllosilicate mineral which is also naturally occurring.

In some embodiments, the intumescent component comprises expandable graphite. In some embodiments the expandable graphite comprises graphite which has been treated in a bath of acid and oxidizing agent, for example hydrogen peroxide, potassium permanganate or chromic acid. In some embodiments the expandable graphite comprises flake graphite, for example Chinese crystalline flake graphite.

In some embodiments, the intumescent component comprises or consists of one or more of perlite, vermiculite and graphite. In some embodiments, the intumescent component comprises one or more of perlite, vermiculite and expandable graphite.

In some embodiments, the intumescent component comprises or consists of both perlite and vermiculite. The combination of these two materials within the intumescent component of the composition may provide enhanced expansion of the composition and suppression of the fire.

In some embodiments, the intumescent component comprises or consists of perlite, vermiculite and expandable graphite. The combination of these three materials within the intumescent component of the fire extinguishing liquid may provide a composition which is particularly effective in quickly extinguishing a Li-ion battery fire when combined with the other components of the fire extinguishing liquid.

In some embodiments, the intumescent component comprises or consists of sawdust. In some embodiments, the intumescent component comprises or consists of a mixture of sawdust and urea. Herein, “sawdust” refers to any wood-based material in the form of shavings or particulates which is a by-product of woodworking processes such as sawing and milling.

In some embodiments, the fire extinguishing liquid comprises:
(a) one or more of a phosphate, hydrogen phosphate, dihydrogen phosphate or polyphosphate salt;
(b) a carbonate or hydrogen carbonate salt;
(c) a sulphate salt;
(d) an intumescent component; and
(e) one or more compounds each independently selected from polyethers, diols and glycol ethers.

Including one or more compounds each independently selected from polyethers, diols and glycol ethers provides the advantage of helping bind together the other components of the composition during use, assisting in the formation of the emulsion barrier which forms when the intumescent component expands.

In some embodiments, component (e) comprises one or more diol compounds. In some embodiments, component (e) consists of a diol compound.

In some embodiments, component (e) comprises one or more of glycerine, propylene glycol, butoxyethanol and hexylene glycol. In some embodiments, component (e) consists of one or more of glycerine, propylene glycol, butoxyethanol and hexylene glycol. In some embodiments, component (e) consists of only one of glycerine, propylene glycol, butoxyethanol and hexylene glycol. In some embodiments, component (e) consists of propylene glycol.

In some embodiments, the fire extinguishing liquid comprises:
(a) one or more of a phosphate, hydrogen phosphate, dihydrogen phosphate or polyphosphate salt;
(b) a carbonate or hydrogen carbonate salt;
(c) a sulphate salt;
(d) an intumescent component; and
(e) propylene glycol (C₃H₈O₂).

The presence of propylene glycol offers several benefits. Firstly, the compound is generally recognised as safe, being used as a food additive, and it is environmentally friendly having little or no detrimental effect when released into the environment.

The fire extinguishing liquid is also able to operate at lower temperatures without freezing due to the presence of propylene glycol in the composition. In some cases, the fire extinguishing liquid may be able to operate at temperatures as low as −20° C. without freezing. As such, the liquid may enable liquid-based fire extinguishers to operate in colder climates, as described above.

Herein, the terms “propylene glycol” and “monopropylene glycol” may be used interchangeably to refer to the compound:

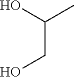

In some embodiments, the fire extinguishing liquid comprises:
(a) diammonium hydrogen phosphate ((NH₄)₂HPO₄);
(b) ammonium bicarbonate (NH₄HCO₃);
(c) ammonium sulphate ((NH₄)₂SO₄);
(d) an intumescent component; and
(e) propylene glycol (C₃H₈O₂).

Preferably, the fire extinguishing liquid is an aqueous solution of the above-mentioned components. In other words, the fire extinguishing liquid may comprise:
(a) one or more of a phosphate, hydrogen phosphate, dihydrogen phosphate or polyphosphate salt;
(b) a carbonate or hydrogen carbonate salt;
(c) a sulphate salt;
(d) an intumescent component;
(e) optionally one or more of glycerine, propylene glycol, butoxyethanol and hexylene glycol; and
(f) water.

In some embodiments, the fire extinguishing liquid further comprises urea. Without wishing to be bound by theory it is believed that urea, when present in the composition, leads to the formation of N₂ and CO₂ gases by reaction with the carbonate or hydrogen carbonate component. These inert gases enhance the fire-suppressing capabilities of the fire extinguishing liquid.

Thus in some embodiments the fire extinguishing liquid comprises:
(a) one or more of a phosphate, hydrogen phosphate, dihydrogen phosphate or polyphosphate salt;
(b) a carbonate or hydrogen carbonate salt;
(c) a sulphate salt;
(d) an intumescent component; and
(g) urea.

In some embodiments the fire extinguishing liquid comprises:
(a) one or more of a phosphate, hydrogen phosphate, dihydrogen phosphate or polyphosphate salt;
(b) a carbonate or hydrogen carbonate salt;
(c) a sulphate salt;
(d) an intumescent component;
(e) optionally one or more of glycerine, propylene glycol, butoxyethanol and hexylene glycol;
(f) a solvent, such as water; and
(g) urea.

In some embodiments, the fire extinguishing liquid comprises sodium chloride. In some embodiments, the fire extinguishing liquid comprises pure dried vacuum salt (PDV). In some embodiments, the fire extinguishing liquid comprises curing salt. The presence of sodium chloride may provide the composition with anticaking and antibacterial properties.

Further optional features of the invention will now be set out. These are applicable singly or in any combination with any aspect of the invention.

The fire extinguishing liquids of the present invention demonstrate good fire extinguishing results against Li-ion battery fires. In preferred embodiments, the components set out above are dissolved in a solvent, preferably water, and more preferably demineralized water.

In order to better understand why the liquid displays these advantageous effects, the mechanism of combustion must first be understood namely the process of: heating 4 decomposition (or gasification) 4 ignition 4 combustion 4 extended chain of flame. Fire retardants or suppressants work by interfering with one or more of the steps in this mechanism. For example they may work by blocking the oxygen supply or forming an oxygen blockade layer; controlling the production of combustion gas; lowering the temperature of the combustibles, or generating incombustible gas and diluting combustible gas.

Examples of fire extinguishing mechanisms are as follows:
(i) Suffocation, in which gases generated by the heating of components in the fire extinguishing liquid (i.e. gas which is vaporized and generated by heat energy of the combustibles), e.g. ammonia, carbon dioxide, nitrogen, or water vapour, have a dilution effect on the combustible gas, and a suffocation effect due to oxygen blockade.
(ii) Endothermic effects, wherein the sublimation, vaporization, decomposition or heating of components within the fire extinguishing liquid (or combustion residues) leads to a temperature fall, as the heat energy released by the fire is expended in heating/vaporizing components of the liquid, rather than stoking the fire.
(iii) Restraining effects, in which the fire extinguishing liquid confines the combustibles, and has a fireproofing effect on said combustibles (i.e. forming a protective layer), both restraining the outbreak of gas and preventing the underlying material from igniting. Alternatively, the non-combustible solid combustion residues may provide the fireproofing effect.

Turning specifically to the components of the liquid of the present invention: without wishing to be bound by theory it is believed that when coming into contact with the heat of a fire, diammonium hydrogen phosphate decomposes according to: (NH₄)₂HPO₄→H₃PO₄+2NH₃, producing ammonia gas. The ammonia has a suffocating effect on the fire, by replacing the oxygen in the surroundings. It also helps to cool the combustibles by its heat of vaporization (see the endothermic effect above). Furthermore, chemical agents which are not vaporized stick to any combustibles, and in so doing make them non-combustible, by the restraining effect described above.

Similar to the diammonium hydrogen phosphate, without wishing to be bound by theory it is believed that when coming into contact with the heat of the fire, the ammonium hydrogen carbonate decomposes according to: NH₄HCO₃→NH₃+CO₂+H₂O. The ammonia has the same effects as for the diammonium hydrogen phosphate. In addition the CO₂ and H₂O also serve to have a suffocating effect on the flames.

Further without wishing to be bound by theory it is believed that ammonium sulphate decomposes by pyrolysis according to (NH₄)₂SO₄→2NH₃+H₂SO₄, followed by the decomposition of the H₂SO₄ product into SO₃ and H₂O. Treating a source of combustion with (NH₄)₂SO₄ lowers the threshold temperature for pyrolysis and combustion and provides an increase in the residue or char production, which further contributes to retardancy.

When monopropylene glycol is present in the fire extinguishing liquid, this lowers the freezing point of the liquid. In doing so, it enables the liquid to be used in colder temperatures, specifically at temperature as low as −20° C. Furthermore, in contrast to other “anti-freezing” agents, monopropylene glycol is advantageous since it is both environmentally friendly and non-toxic. Being able to operate at lower temperatures is especially useful, for example, in cold countries where prior art fire extinguishing liquid would freeze, greatly reducing its effectiveness. Prior to now, it was necessary to use powder or CO₂ based extinguishers in such cold countries.

Preferably, at atmospheric pressure, the fire extinguishing liquid has a freezing point of at most 0° C., for example at most −5° C., at most −10° C., at most −15° C. or at most −20° C.

In some embodiments, the molar ratio in the fire extinguishing liquid of the phosphate, hydrogen phosphate, dihydrogen phosphate or polyphosphate anion in (a), to the carbonate or hydrogen carbonate anion in (b), is from 1:1 to 20:1, for example from 5:1 to 20:1, preferably from 6:1 to 15:1.

In some embodiments, the molar ratio in the fire extinguishing liquid of the phosphate, hydrogen phosphate, dihydrogen phosphate or polyphosphate anion in (a), to the sulphate anion in (c), is from 2:1 to 15:1, for example from 3:1 to 15:1, preferably from 4:1 to 10:1.

In some embodiments, the molar ratio in the fire extinguishing liquid of the phosphate, hydrogen phosphate, dihydrogen phosphate or polyphosphate anion in (a), to the glycerine, propylene glycol, butoxyethanol and hexylene glycol in (d), is from 0.3:1 to 10:1, for example from 0.3:1 to 8:1, from 0.3:1 to 0.8:1, from 4:1 to 7:1, or from 0.4:1 to 0.7:1.

In some embodiments, the fire extinguishing liquid also comprises water as a solvent, alongside the components mentioned above, such that the liquid is an aqueous solution of the specified components. In some embodiments, the molar ratio in the fire extinguishing liquid of the phosphate, hydrogen phosphate, dihydrogen phosphate or polyphosphate anion in (a), to water, is from 0.01:1 to 0.5:1, preferably from 0.03:1 to 0.2:1, for example from 0.03:1 to 0.05:1.

Such ratios of components have been found to lead to enhanced firefighting abilities of the fire extinguishing liquid.

In the following description, unless otherwise specified, percentages refer to weight percentages (wt %). By “weight percentage”, we mean the percentage by weight relative to the total weight of the liquid.

In some embodiments, the liquid comprises at least 5 wt % of component (a) (one or more of a phosphate, hydrogen phosphate, dihydrogen phosphate or polyphosphate salt), for example at least 6 wt %, at least 7 wt %, at least 8 wt %, at least 9 wt %, at least 10 wt % or at least 11 wt %. In some embodiments, the liquid comprises up to 25 wt % component (a), for example up to 24 wt %, up to 23 wt %, up to 22 wt %, up to 21 wt %, up to 19 wt %, up to 18 wt %, up to 17 wt %, up to 16 wt %, up to 15 wt % or up to 14 wt %.

In some embodiments, the liquid comprises from 10 wt % to 20 wt % of component (a), for example from 12 wt % to 20 wt % or from 14 wt % to 20 wt %.

In some embodiments, the liquid comprises at least 0.01 wt % component (b) (carbonate or hydrogen carbonate salt), for example at least 0.02 wt %, at least 0.03 wt %, at least 0.04 wt %, at least 0.05 wt %, at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt % or at least 1.0 wt %. In some embodiments, the liquid comprises up to 10 wt % component (b), for example up to 9 wt %, up to 8 wt %, up to 7 wt %, up to 6 wt %, up to 5 wt % or up to 4 wt %.

In some embodiments, the liquid comprises from 1 wt % to 7 wt % of component (b), for example from 1.5 wt % to 6.5 wt %.

In some embodiments, the liquid comprises at least 0.01 wt % component (c) (sulphate salt), for example at least 0.02 wt %, at least 0.03 wt %, at least 0.04 wt %, at least 0.05 wt %, at least 0.1 wt %, at least 0.2 wt %, at least 0.3 wt %, at least 0.4 wt %, at least 0.5 wt %, at least 1.0 wt %, at least 1.5 wt %, at least 2 wt %, at least 2.5 wt % or at least 3 wt %. In some embodiments, the liquid comprises up to 10 wt % component (c), for example up to 9 wt %, up to 8 wt %, up to 7 wt %, up to 6 wt %, up to 5 wt % or up to 4 wt %.

In some embodiments, the liquid comprises from 4 wt % to 8 wt % of component (c), for example from 4 wt % to 7 wt % or from 4.5 wt % to 6.5 wt %.

In some embodiments, the liquid comprises at least 8 wt % component (d) (intumescent component), for example at least 9 wt %, at least 10 wt %, at least 12 wt %, at least 14 wt %, at least 15 wt %, at least 16 wt %, at least 17 wt %, at least 18 wt %, at least 19 wt %, at least 20 wt %, at least 21 wt %, at least 22 wt %, at least 23 wt %, at least 24 wt % or at least 25 wt %.

In some embodiments, the liquid comprises up to 40 wt % intumescent component, for example up to 35 wt %, up to 34 wt %, up to 33 wt %, up to 32 wt %, up to 31 wt % or up to 30 wt %.

In some embodiments, the liquid comprises from 8 to 34 wt % intumescent component. In some embodiments, the liquid comprises from 25 to 34 wt % intumescent component. In some embodiments, the liquid comprises from 8 to 15 wt % intumescent component, for example from 8 to 12 wt %, from 9 to 12 wt %, from 10 to 12 wt % or from 11 to 12 wt %.

Amounts of intumescent component within these ranges may provide enhanced fire suppressing properties for the composition.

In some embodiments, the liquid comprises at least 0.5 wt % component (e) (one or more of glycerine, propylene glycol, butoxyethanol and hexylene glycol), for example at least 0.6 wt %, at least 0.7 wt %, at least 0.8 wt %, at least 0.9 wt %, at least 1.0 wt %, at least 1.1 wt %, at least 1.2 wt %, at least 1.3 wt % or at least 1.4 wt %. In some embodiments, the liquid comprises up to 20 wt % component (e), for example up to 10 wt %, up to 9 wt %, up to 8 wt %, up to 7 wt %, up to 6 wt %, up to 5 wt %, up to 4 wt % or up to 2 wt %.

In some embodiments, the liquid comprises at least 10 wt % component (e) (one or more of glycerine, propylene glycol, butoxyethanol and hexylene glycol), for example at least 10.5 wt %, at least 11 wt %, at least 11.5 wt %, at least 12 wt %, at least 12.5 wt %, at least 13 wt %, at least 13.5 wt %, at least 14 wt %, at least 14.5 wt % or at least 15 wt %. In some embodiments, the liquid comprises up to 20 wt % component (e), for example up to 19.5 wt %, up to 19 wt %, up to 18.5 wt %, up to 18 wt %, up to 17.5 wt % or up to 17 wt %.

In some embodiments, the liquid comprises from 1 wt % to 10 wt % component (e), for example from 1 to 8 wt %, from 1 to 5 wt %, from 1 to 3 wt % or from 1 wt % to 2 wt % of component (e).

In some embodiments, alongside the above components the liquid comprises balance solvent, preferably water, more preferably demineralised water. In some embodiments, the liquid comprises at least 30 wt % water, for example at least 35 wt %, at least 40 wt %, at least 45 wt % or at least 50 wt %. In some embodiments, the liquid comprises up to 70 wt % water, for example up to 65 wt % or up to 60 wt %.

In some embodiments, the liquid comprises from 50 wt % to 80 wt % water, for example demineralised water, for example from 50 wt % to 70 wt % or from 50 wt % to 60 wt %.

In some embodiments, the liquid comprises
6 to 24 wt %, for example 10 to 20 wt % diammonium hydrogen phosphate;
0.01 to 8 wt %, for example 1 to 7 wt % ammonium bicarbonate;
0.01 to 10 wt %, for example 3 to 8 wt % ammonium sulphate;
5 to 34 wt % intumescent component, for example 25 to 34 wt %;
optionally 0.5 to 6 wt %, for example 2 to 5 wt % firefighting foam component; and
balance water, to provide a total of 100 wt %.

In some embodiments, the liquid comprises
6 to 24 wt %, for example 10 to 20 wt % diammonium hydrogen phosphate;
0.01 to 8 wt %, for example 1 to 7 wt % ammonium bicarbonate;
0.01 to 10 wt %, for example 3 to 8 wt % ammonium sulphate;
5 to 34 wt % intumescent component, for example 25 to 34 wt %;
optionally 0.5 to 6 wt %, for example 2 to 5 wt % firefighting foam component; and
50 to 70 wt % water;
   wherein the amount of all components totals 100 wt %.

In some embodiments, the liquid comprises
6 to 24 wt % diammonium hydrogen phosphate;
0.01 to 7 wt % ammonium bicarbonate;
0.01 to 10 wt % ammonium sulphate;
10 to 34 wt % intumescent component;
1.0 to 20 wt % monopropylene glycol;
optionally 0.5 to 4 wt % firefighting foam component; and
balance water, to provide a total of 100 wt %.

In some embodiments, the liquid comprises
6 to 24 wt % diammonium hydrogen phosphate;
0.01 to 7 wt % ammonium bicarbonate;
0.01 to 10 wt % ammonium sulphate;
10 to 34 wt % intumescent component;
1.0 to 20 wt % monopropylene glycol;
optionally 0.5 to 4 wt % firefighting foam component; and
50 to 70 wt % water;
   wherein the amount of all components totals 100 wt %.
The liquid may contain 50% to 70% water, and more preferably 55% to 65% water, and more preferably still 58% to 60% water.
The liquid may contain 6% to 24% diammonium hydrogen phosphate, and more preferably 10% to 20% diammonium hydrogen phosphate.
The liquid may contain 0.01% to 5% ammonium bicarbonate, and more preferably 0.5% to 3% ammonium bicarbonate, and more preferably still 1% to 2% ammonium bicarbonate.
The liquid may contain 0.01% to 10% ammonium sulphate, and more preferably 2% to 5% ammonium sulphate, and more preferably still 3% to 4% ammonium sulphate.
The liquid may contain 10% to 20% monopropylene glycol, and more preferably 12.5% to 17.5% monopropylene glycol, and more preferably still 15% to 17% monopropylene glycol.

In some embodiments, the weight ratio of diammonium hydrogen phosphate to ammonium bicarbonate in the extinguishing liquid is at least 2:1, for example at least 2.1:1, at least 2.2:1, at least 2.3:1, at least 2.4:1 or at least 2.5:1. In some embodiments, the weight ratio of diammonium hydrogen phosphate to ammonium bicarbonate in the extinguishing liquid is at least 3:1, for example at least 4:1, at least 5:1, at least 6:1, at least 7:1 or at least 8:1.

In some embodiments, the weight ratio of diammonium hydrogen phosphate to ammonium sulphate in the extinguishing liquid is at least 2:1, for example at least 2.1:1, at least 2.2:1, at least 2.3:1, at least 2.4:1 or at least 2.5:1. In some embodiments, the weight ratio of diammonium hydrogen phosphate to ammonium sulphate in the extinguishing liquid is at least 3:1, for example at least 3.5:1 or at least 4.0:1.

The fire extinguishing liquid may further include a firefighting foam component. Such a component both adds to the cooling effect of the liquid, and coats the combustible material, preventing oxygen contact and suppressing combustion. The foam component may include a surfactant, to lower the surface tension of the water in the foam. By lowering the surface tension, the water is able to better wet the surface of the combustible material, further reducing oxygen contact. In preferred embodiments, the firefighting foam component is a firefighting foam. In some embodiments, the firefighting foam component is an aqueous film forming foam (AFFF), such as FOMTEC® AFFF 3%. The selection of firefighting foam component may depend on the particular intended application of the fire extinguishing liquid, as would be understood by the skilled person.

In some embodiments, the firefighting foam component comprises diethylene glycol monobutyl ether, sulphuric acid mono-C6-C12-alkyl esters sodium salts, propan-1,2-diol, alkyl polyglycoside and ethylene oxide polymer.

In some embodiments, the firefighting foam component comprises 2-methylpentane-2-4-diol, sodium decyl sulphate and sodium octyl sulphate.

In some embodiments, the liquid contains at least 0.5% firefighting foam component, for example at least 0.6%, at least 0.7%, at least 0.8%, at least 2%, at least 2.5%, at least 3%, at least 3.5%, at least 4% or at least 4.5%. The inventors have found that the firefighting abilities of the liquid are dramatically improved when the composition comprises at least 6% firefighting foam component, for example at least 6.5%, at least 7%, at least 7.5%, at least 8%, at least 8.5%, at least 9% or at least 9.5%.

In some embodiments, the liquid contains up to 12% firefighting foam component, for example up to 11.5%, up to 11% or up to 10.5%.

In some embodiments, the fire extinguishing liquid comprises:
(a) one or more of a phosphate, hydrogen phosphate, dihydrogen phosphate or polyphosphate salt;
(b) a carbonate or hydrogen carbonate salt;
(c) a sulphate salt;
(d) the intumescent component;
(e) one or more of glycerine, propylene glycol, butoxyethanol and hexylene glycol;
(f) a solvent, such as water;
(g) urea;
(h) sodium chloride; and
(i) the firefighting foam component.

In some embodiments, the fire extinguishing liquid comprises:
(a) diammonium hydrogen phosphate ((NH₄)₂HPO₄);
(b) ammonium bicarbonate (NH₄HCO₃);
(c) ammonium sulphate ((NH₄)₂SO₄);
(d) an intumescent component comprising vermiculite and perlite, and optionally expandable graphite;
(e) optionally one or more of glycerine, propylene glycol, butoxyethanol and hexylene glycol;
(f) a solvent, such as water;
(g) urea;
(h) sodium chloride; and
(i) the firefighting foam component.

The liquid may comprise urea. In some embodiments the liquid comprises at least 0.5 wt % urea, for example at least 1 wt %, at least 1.5 wt % or at least 2 wt %. In some embodiments, the liquid comprises up to 5 wt % urea, for example up to 4 wt % or up to 3 wt %. The liquid may comprise from 0.5 to 5 wt % urea, for example from 0.5 to 4 wt %, from 1 to 4 wt %, from 1 to 3 wt % or from 2 to 3 wt %.

It has been found that liquids having compositions falling within the ranges set out above demonstrate improved fire extinguishing capabilities when used against Li-ion battery fires. For example, such liquids may provide reduced extinguishing time, reduced residual temperatures and/or a reduced quantity of liquid necessary to achieve extinguishment.

A second aspect of the invention is a method of manufacturing a fire extinguishing liquid comprising the step of mixing (a) one or more of a phosphate, hydrogen phosphate, dihydrogen phosphate or polyphosphate salt; (b) a carbonate or hydrogen carbonate salt; (c) a sulphate salt; and (d) an intumescent component; and a liquid vehicle. In some embodiments, the liquid vehicle is water, preferably demineralised water.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄), an intumescent component and the liquid vehicle.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄), vermiculite and the liquid vehicle.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄), perlite and the liquid vehicle.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄), vermiculite, perlite and the liquid vehicle.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄), vermiculite, perlite; one or more of glycerine, propylene glycol, butoxyethanol and hexylene glycol; and the liquid vehicle.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄), vermiculite, perlite, expandable graphite and the liquid vehicle.

In some embodiments, the method comprises the step of mixing diammonium hydrogen phosphate ((NH₄)₂HPO₄), ammonium bicarbonate (NH₄HCO₃), ammonium sulphate ((NH₄)₂SO₄), vermiculite, perlite, expandable graphite, urea and the liquid vehicle.

In some embodiments, the method further comprises mixing propylene glycol (C₃H₈O₂) with the diammonium hydrogen phosphate ((NH₄)₂HPO₄), ammonium bicarbonate (NH₄HCO₃), ammonium sulphate ((NH₄)₂SO₄) and liquid vehicle.

In some embodiments, the method of manufacturing the fire extinguishing liquid comprises the steps of:
(A) heating water to a temperature above room temperature;
(B) adding diammonium hydrogen phosphate ((NH₄)₂HPO₄), ammonium bicarbonate (NH₄HCO₃) and ammonium sulphate ((NH₄)₂SO₄) to the water; and
(C) adding the intumescent component to the water.

In some embodiments the method further comprises adding propylene glycol (C₃H₈O₂) to the water in step (B).

In some embodiments, the method further comprises the addition of the firefighting foam component described above.

In some embodiments, the method comprises mixing the solution after the addition of one or more of diammonium hydrogen phosphate ((NH₄)₂HPO₄), ammonium bicarbonate (NH₄HCO₃), ammonium sulphate ((NH₄)₂SO₄) and propylene glycol (C₃H₈O₂).

In some embodiments, the method comprises:
(A) heating water to a temperature of from 21° C. to 40° C.;
(B) adding diammonium hydrogen phosphate ((NH₄)₂HPO₄), ammonium bicarbonate (NH₄HCO₃) and ammonium sulphate ((NH₄)₂SO₄) to the water;
(C1) heating the solution up to a temperature in the range 60° C. to 70° C., mixing the solution and then allowing the solution to cool to a temperature below 40° C.; and
(C2) adding the intumescent component to the water.

In some embodiments, after step (C) the method includes an additional step (D) of cooling the solution to below 25° C.

In some embodiments, after step (D) the method includes an additional step (E) of filtering the solution to remove undissolved residue. This filtering step may be carried out using any well-known filtration technique, including but not limited to passing the solution through filter paper or a sieve.

‘Room temperature’ refers to a temperature of around 21° C.

In some embodiments, the water is first heated in step (A) to a temperature in the range 30 to 70° C. before any of the other components are added. This leads to improved dissolution of the other components of the composition. In some embodiments, the heating is carried out using an immersion heater, such as an electric element within the mixing tank. Other suitable methods of heating the water are known to the skilled person.

In preferred embodiments, one or more of the diammonium hydrogen phosphate ((NH₄)₂HPO₄), ammonium bicarbonate (NH₄HCO₃) and ammonium sulphate ((NH₄)₂SO₄) are provided in powder form, wherein the powder has an average particle size (D50) of about 1 to 10 μm, for example about 2 to 8 μm, for example about 5 μm. D50 particle size may be determined using laser diffraction with a Malvern Mastersizer 3000 according to ASTM B822-20, applying the Mie scattering theory. Providing powder having such small particle sizes allows for a reduction in the temperature of the water during the manufacturing method, which improves the efficiency and safety of the process. In some embodiments, each of the diammonium hydrogen phosphate ((NH₄)₂HPO₄), ammonium bicarbonate (NH₄HCO₃) and ammonium sulphate ((NH₄)₂SO₄) are provided in powder form, wherein the powder has an average particle size of about 1 to 10 μm, for example about 2 to 8 μm, for example about 5 μm. In some embodiments, when powder of such particle size is provided, step (A) comprises heating water to a temperature of from room temperature up to 45° C., for example from room temperature up to 40° C.

In some embodiments, each of diammonium hydrogen phosphate ((NH₄)₂HPO₄), ammonium bicarbonate (NH₄HCO₃), ammonium sulphate ((NH₄)₂SO₄) and optionally propylene glycol (C₃H₈O₂) are added to the water separately. In some embodiments, diammonium hydrogen phosphate ((NH₄)₂HPO₄) is added to the water in a first step, followed by the remaining components. In some embodiments, propylene glycol (C₃H₈O₂) is added after each of diammonium hydrogen phosphate ((NH₄)₂HPO₄), ammonium bicarbonate (NH₄HCO₃) and ammonium sulphate ((NH₄)₂SO₄) have been added.

In some embodiments, the method of manufacturing the fire extinguishing liquid comprises the steps of:
(i) heating water to a temperature above room temperature, preferably to a temperature in the range 30 to 70° C.;
(ii) adding diammonium hydrogen phosphate and mixing until dissolved;
(iii) adding ammonium bicarbonate and mixing until dissolved;
(iv) adding ammonium sulphate and mixing until dissolved;
(v) adding the intumescent component and mixing; and
(vi) optionally adding monopropylene glycol and mixing until dissolved.

Preferably, after step (iv) the mixture is cooled to a temperature below 40° C. before the addition of the intumescent component in step (v).

Preferably, during the addition of monopropylene glycol in step (vi) the temperature of the liquid is about 20° C.

In some embodiments, after optional step (vi) the method includes an additional step (vii) of cooling the solution of water, diammonium hydrogen phosphate, ammonium bicarbonate and ammonium sulphate to below 25° C.

In some embodiments, after step (vii) the method includes an additional step (viii) of filtering the solution to remove undissolved residue. This filtering step may be carried out using any well-known filtration technique, including but not limited to passing the solution through filter paper or a sieve.

The amount of each component added to the water is preferably selected to arrive at a composition having:
50% to 70% of water, and more preferably 55% to 65% of water, and more preferably still 57% to 60% of water.
6% to 24% diammonium hydrogen phosphate, and more preferably 14% to 25% diammonium hydrogen phosphate, and more preferably still 16% to 20% diammonium hydrogen phosphate.
0.01% to 8% ammonium bicarbonate, and more preferably 0.5% to 7% ammonium bicarbonate, and more preferably still 1% to 2% ammonium bicarbonate.
0.01% to 10% ammonium sulphate, and more preferably 2% to 7% ammonium sulphate, and more preferably still 4% to 7% ammonium sulphate.
1.0% to 20% monopropylene glycol, and more preferably 1.0% to 5.0% monopropylene glycol, and more preferably still 1.0% to 2.0% monopropylene glycol.

In steps (ii) to (iv), the components are preferably added to the mixture in their natural physical form, that is in solid form, preferably in the form of grains or a powder. Throughout these steps the diammonium hydrogen phosphate, ammonium bicarbonate and the ammonium sulphate are preferably added while the mixture is being mixed or stirred. In optional step (vi) the monopropylene glycol is preferably added in its natural physical form, namely in liquid form.

The method may further include a step of adding a firefighting foam component as described earlier in the application. As above, the weight of firefighting foam component is preferably selected to arrive at an overall composition having 0.5% to 6%, for example 0.5% to 4% of firefighting foam component.

The method may further comprise adding urea to the liquid. As above, the weight of firefighting foam component is preferably selected to arrive at an overall composition having from 0.5 to 5 wt % urea, for example from 0.5 to 4 wt %, from 1 to 4 wt %, from 1 to 3 wt % or from 2 to 3 wt %.

By heating the water first, in step (i), the dissolution of soluble components in steps (ii) to (vi) is improved. In preferred embodiments, the addition of the diammonium hydrogen phosphate is carried out in small increments. In this way, the chance of a rapid reduction in the temperature of the water is prevented, which may otherwise lead to a reduction in solubility. Specifically, in preferred embodiments, after a small amount of diammonium hydrogen phosphate is added to the water, that small amount should dissolve fully before a second small amount is added. In some embodiments, the total amount of diammonium hydrogen phosphate is added to the liquid vehicle in two or more batches, for example three, four or five batches, allowing for full dissolution, preferably with mixing, after each batch addition. In some embodiments, after all of the diammonium hydrogen phosphate is added, the mixture is mixed or stirred for 10 to 30 minutes to ensure an even distribution of the diammonium hydrogen phosphate throughout the mixture. Furthermore, throughout the addition steps (ii) to (v), it is preferable that the water is maintained at a temperature from 30° C. to 70° C., in order to aid the dissolution of the diammonium hydrogen phosphate, ammonium bicarbonate and ammonium sulphate in steps (ii) to (v) respectively.

After step (iii), the mixture may be mixed or stirred for 5 to 20 minutes, again to ensure uniform distribution of the ammonium bicarbonate throughout the mixture. More preferably, the mixture is mixed or stirred for about 10 minutes. For the same reason, after the addition of ammonium sulphate in step (iv), the mixture may be mixed or stirred for a further 20 to 40 minutes, and preferably for about 20 minutes.

In step (vii), it is preferable that the water is cooled to below 25° C., for example below 24° C., below 23° C., below 22° C., below 21° C. or below 20° C. In some embodiments, the solution is left to cool naturally for a period of at least 5 hours, such as at least 6 hours, at least 7 hours or at least 8 hours. By cooling the mixture to a temperature which is approximately room temperature, the capacity of the water to hold the diammonium hydrogen phosphate, ammonium bicarbonate and ammonium sulphate in solution is decreased. As a result, a portion of any or all of these components may precipitate out of solution. Clearly, it is undesirable that this happens when the liquid has been packaged in e.g. a fire extinguisher. For example, such precipitation may cause the solid grains to block the extinguisher nozzle or any valves within extinguishers or aerosols, which risks reducing its effectiveness, or even rendering the fire extinguisher completely inoperable. So, the combination of the cooling in step (vii) and the filtering in step (viii), which removes any diammonium hydrogen phosphate, ammonium bicarbonate and ammonium sulphate which may have precipitated as a result of cooling, and also any undissolved residues or impurities, ensures that the liquid does not contain any solid particulate matter which could block or damage a fire extinguisher in which the liquid may be contained.

The filtering may be performed using a mesh, the mesh size (i.e. the average size of the holes in the mesh) of which, is preferably selected to catch (i.e. filter out) particles whose dimensions are such that they risk damaging or blocking a fire extinguisher. For example, the mesh size may be 0.5 mm or less. More preferably the mesh size is 0.1 mm or less, and more preferably still, the mesh size is 0.05 mm or less.

The method may include a further step of filling a fire extinguisher with the liquid. Step (viii), the filtering step, may take place as the fire extinguisher is being filled, in order to minimize the number of steps in the manufacturing process.

A third aspect of the present invention provides a fire extinguisher (i.e., a fire extinguishing device) containing the liquid according to the first aspect of the present invention. The liquid may include any of the optional features which have been set out above with respect to the first and second aspects of the invention, where compatible.

A variety of fire extinguishing devices may be used to contain and deliver the fire extinguishing liquid according to the invention. For example, self-contained hand-held pressurised extinguishers may be used, wherein the liquid is delivered through a nozzle. The liquid may also be added to a sealed sachet, which could find use for example in fighting pan fires in a domestic environment. More sophisticated fire-fighting systems could also employ the fire extinguishing liquid of the invention, for example hose reel jets, high pressure hose reel jets, compressed air foam systems and ultra high pressure lance systems. Such systems are more suited for use by professional fire-fighters, such as fire and rescue service crew.

The liquid may be used in its concentrated form according to a composition as described herein, or may be diluted further with a liquid vehicle such as water. For example, the liquid may be diluted with water to provide a weight ratio of extinguishing liquid:water in the range of from 4:96 to 50:50, preferably from 6:94 to 30:70.

### EXAMPLES

### Example 1

The ingredients listed in Table 1 were combined in the stated proportions to produce two fire extinguishing liquids (Composition A and Composition B).

TABLE 1

| | Composition A | | Composition B | |
|---|---|---|---|---|
| | Amount | Weight % of | Amount | Weight % of |
| Component | (kg) | composition | (kg) | composition |
| Diammonium | 245 | 19.5 | 180 | 14.2 |
| hydrogen phosphate | | | | |
| ((NH₄)₂HPO₄) | | | | |
| Ammonium | 24 | 1.9 | 80 | 6.3 |
| bicarbonate | | | | |
| (NH₄HCO₃) | | | | |
| Ammonium sulphate | 60 | 4.8 | 80 | 6.3 |
| ((NH₄)₂SO₄) | | | | |
| AFFF concentrate | 35 | 2.8 | 10 | 0.8 |
| Demineralised water | 727 | 58.0 | 730 | 57.4 |
| Vermiculite | 60 | 4.8 | 80 | 6.3 |
| Perlite | 55 | 4.4 | 40 | 3.1 |
| Natural flake | 30 | 2.4 | 20 | 1.6 |
| graphite | | | | |
| Monopropylene | 18 | 1.4 | 22 | 1.7 |
| glycol | | | | |
| Urea | 0 | 0 | 30 | 2.4 |
| TOTAL | 1,254 | 100 | 1,272 | 100 |

The diammonium hydrogen phosphate ((NH₄)₂HPO₄), ammonium bicarbonate (NH₄HCO₃) and ammonium sulphate ((NH₄)₂SO₄) were all provided in powder having a D50 particle size of around 5 μm.

The method used to prepare the Compositions in each case was as follows:
1) Distilled water was added to a large metal container with heated walls and multiple stirring paddles, and the water was heated to 30° C.;
2) The (NH₄)₂HPO₄, NH₄HCO₃ and (NH₄)₂SO₄ were added to the water;
3) The mixture was heated up to 65° C. with mixing;
4) The solution was cooled to 40° C. before adding the vermiculite, perlite and flake graphite;
5) The solution was allowed to cool to room temperature and the remaining ingredients were added to produce the final liquid.

1. A fire extinguishing liquid comprising:
(a) one or more of a phosphate, hydrogen phosphate, dihydrogen phosphate or polyphosphate salt;
(b) a carbonate or hydrogen carbonate salt;
(c) a sulphate salt; and
(d) an intumescent component.

2. The fire extinguishing liquid according to claim 1, wherein the intumescent component comprises vermiculite.

3. The fire extinguishing liquid according to claim 1, wherein the intumescent component comprises perlite.

4. The fire extinguishing liquid according to claim 1, wherein the intumescent component comprises expandable graphite.

5. The fire extinguishing liquid according to claim 1, wherein the salts are all dissolved in a liquid vehicle, optionally wherein the liquid vehicle is water, preferably demineralized water.

6. (canceled)

7. The fire extinguishing liquid according to claim 1, further comprising urea.

8. The fire extinguishing liquid according to claim 1, further comprising one or more of glycerine, propylene glycol, butoxyethanol and hexylene glycol.

9. The fire extinguishing liquid according to claim 1, wherein the one or more phosphate, hydrogen phosphate, dihydrogen phosphate or polyphosphate salt comprises diammonium hydrogen phosphate ((NH₄)₂HPO₄).

10. The fire extinguishing liquid according to claim 1, wherein the carbonate or hydrogen carbonate salt comprises ammonium bicarbonate (NH₄HCO₃).

11. The fire extinguishing liquid according to claim 1, wherein the sulphate salt comprises ammonium sulphate ((NH₄)₂SO₄).

12. The fire extinguishing liquid according to claim 1, further including a firefighting foam component, optionally wherein the firefighting foam component includes a surfactant.

13. (canceled)

14. The fire extinguishing liquid according to claim 12, wherein the firefighting foam component is an aqueous film forming foam (AFFF).

15. A method of manufacturing a fire extinguishing liquid comprising the step of mixing (a) one or more of a phosphate, hydrogen phosphate, dihydrogen phosphate salt or polyphosphate salt; (b) a carbonate or hydrogen carbonate salt; (c) a sulphate salt; (d) an intumescent component and a liquid vehicle,
optionally wherein:
component (a) is diammonium hydrogen phosphate ((NH₄)₂HPO₄),
component (b) is ammonium bicarbonate (NH₄HCO₃), and
component (c) is ammonium sulphate ((NH₄)₂SO₄).

16. (canceled)

17. The method according to claim 15, wherein the liquid vehicle is water.

18. The method according to claim 15, further including the step of adding one or more of sodium chloride, urea, glycerine, propylene glycol, butoxyethanol, hexylene glycol and a firefighting foam component.

19. The method according to claim 15, further including the step of filling a fire extinguisher with the fire extinguishing liquid, optionally wherein a filtering step is performed as the fire extinguisher is being filled.

20. (canceled)

21. (canceled)

22. (canceled)

23. Use of an intumescent component as a fire suppressing additive in a fire extinguishing liquid, wherein the fire extinguishing liquid further comprises (a) one or more of a phosphate, hydrogen phosphate, dihydrogen phosphate or polyphosphate salt; (b) a carbonate or hydrogen carbonate salt; and (c) a sulphate salt.

24. The use according to claim 23, wherein component (a) is diammonium hydrogen phosphate ((NH₄)₂₁PO₄), component (b) is ammonium bicarbonate (NH₄HCO₃), and component (c) is ammonium sulphate ((NH₄)₂SO₄).

25. (canceled)
